(19) United States
(12) Patent Application Publication
(10) Pub. No.: US 2013/0166106 A1
(43) Pub. Date: Jun. 27, 2013

(54) PORTABLE INFORMATION PROCESSING APPARATUS, HOST APPARATUS, AND VEHICLE CONTROL METHOD

(71) Applicant: Kabushiki Kaisha Toshiba, Tokyo (JP)

(72) Inventor: Hideyuki NAKAGAWA, Fuchu-shi (JP)

(73) Assignee: KABUSHIKI KAISHA TOSHIBA, Tokyo (JP)

(21) Appl. No.: 13/684,108

(22) Filed: Nov. 21, 2012

(30) Foreign Application Priority Data
Dec. 27, 2011 (JP) 2011-286884

(51) Int. Cl. G06F 17/00

(52) U.S. Cl. CPC G06F 17/00
USPC 701/2

(57) ABSTRACT

According to one embodiment, a portable information processing apparatus capable of wireless communication with a host apparatus inquires whether a state of the host apparatus is a first state capable of applying a personal setting to the vehicle. The portable information processing apparatus uploads the first setting information. The portable information processing apparatus inquires whether the state of the host apparatus is a second state. The portable information processing apparatus e downloads second setting information so as to reflect the second setting information on the first setting information in the portable information processing apparatus, if the host apparatus is in the second state.

### CROSS-REFERENCE TO RELATED APPLICATIONS

This application is based upon and claims the benefit of priority from prior Japanese Patent Application No. 2011-286884, filed Dec. 27, 2011, the entire contents of which are incorporated herein by reference.

### FIELD

Embodiments described herein relate generally to a portable information processing apparatus, a host apparatus, and a vehicle control method to be used to control a vehicle such as an automobile.

### BACKGROUND

In the fields of the vehicle such as the automobile, a technique of automatically reflecting personal settings such as a “driving position” on the vehicle has recently had a great deal of attention.

The vehicle is equipped with a host information apparatus for controlling the vehicle. The host information apparatus, for example, recognizes the ID of the electronic key of the automobile and loads, from a storage apparatus, personal setting information corresponding to the ID of the electronic key. A vehicle setting is performed by the host information apparatus in accordance with the loaded personal setting information.

Use of a shared automobile called car sharing is coming into popularization in recent years. In the car sharing, a plurality of users share one automobile. Then, it is necessary to store in advance a plurality of personal settings corresponding to the plurality of users in the storage apparatus of the host information apparatus. In addition, a plurality of electronic keys with different IDs need to be prepared for one automobile. This allows each of the users who share the one automobile to use the electronic keys with different IDs.

In the car sharing, the plurality of pieces of the personal setting information corresponding to each of the plurality of users need to be stored in the host information apparatus, as described above. However, if the number of users who share one automobile increases, the host information apparatus needs to have a larger memory capacity to store the plurality of pieces of the personal setting information. Additionally, in the car sharing, one user may use a plurality of automobiles. In this case, the personal setting information corresponding to this user needs to be stored in advance in the host information apparatus of each of the plurality of automobiles.

It is therefore necessary to prevent the memory capacity from becoming too large to store the plurality of pieces of the personal setting information in the host information apparatus. It is also necessary to implement a method that allows to set the personal setting in the host information apparatus of each of the plurality of automobiles without using the method of storing in advance the personal setting information in the host information apparatus of each of the plurality of automobiles.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view showing the outline of a system including a portable information processing apparatus and a host apparatus according to an embodiment;

FIG. 2 is an exemplary block diagram showing the system configuration of the portable information processing apparatus according to the embodiment;

FIG. 3 is an exemplary block diagram showing the system configuration of the host apparatus according to the embodiment;

FIG. 4 is an exemplary sequence chart showing an example of upload processing of the personal setting information to be executed by the portable information processing apparatus according to the embodiment;

FIG. 5 is an exemplary sequence chart showing an example of download processing of the personal setting information to be executed by the portable information processing apparatus according to the embodiment;

FIG. 6 is an exemplary flowchart for explaining an example of the procedure of the upload processing of the personal setting information to be executed by the portable information processing apparatus according to the embodiment; and

FIG. 7 is an exemplary flowchart for explaining an example of the procedure of the download processing of the personal setting information to be executed by the portable information processing apparatus according to the embodiment.

### DETAILED DESCRIPTION

Various embodiments will be described hereinafter with reference to the accompanying drawings.

In general, according to one embodiment, a portable information processing apparatus capable of wireless communication with a host apparatus installed in a vehicle includes a connection module, a first query module, an upload module, a second query module, and a download module. The connection module establishes a wireless connection between the portable information processing apparatus and the host apparatus. The first query module inquires of the host apparatus via the wireless connection whether a state of the host apparatus is a first state capable of applying a personal setting to the vehicle, wherein the personal setting is represented by first setting information stored in the portable information processing apparatus. The upload module uploads the first setting information to the host apparatus via the wireless connection if the host apparatus is in the first state. The second query module inquires of the host apparatus via the wireless connection whether the state of the host apparatus is a second state in which the personal setting has applied to the vehicle. The download module downloads second setting information concerning the first setting information and representing current setting contents of the vehicle from the host apparatus via the wireless connection so as to reflect the second setting information on the first setting information in the portable information processing apparatus, if the host apparatus is in the second state.

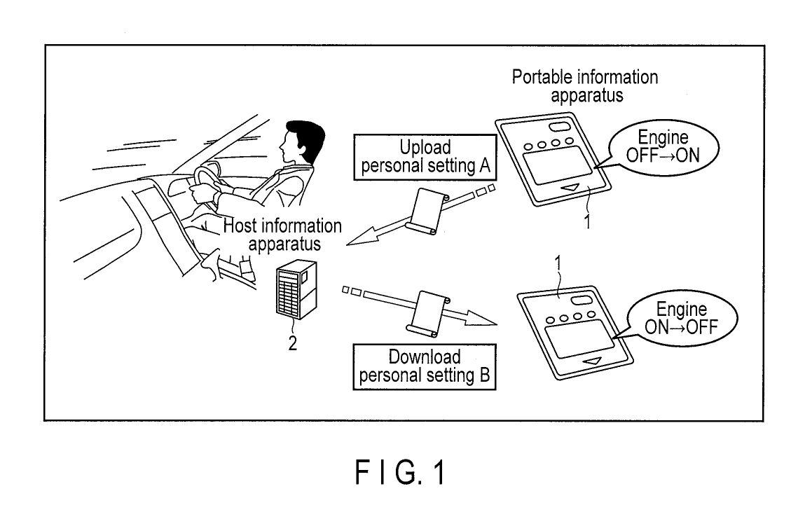

The outline of a system according to the embodiment will be described first with reference to FIG. 1.

The system of this embodiment is an onboard system suitable for car sharing in which a plurality of users share a vehicle (car) such as an automobile. In the car sharing, one automobile is used by the plurality of users (a plurality of drivers).

In case that a user drives the automobile, setting (to be referred to as personal setting information hereinafter) unique to the user can be performed for the automobile to be driven. The personal setting information is setting information representing a personal setting concerning the vehicle such. The personal setting information is setting information necessary for the user to do optimum driving and includes, for example, a “driving position”. The personal setting information is setting information that is different between each of users. In the car sharing, the plurality of users use one automobile by turns. For this reason, each of users needs to set the personal setting information in the automobile every time he/she uses the automobile.

As shown in FIG. 1, the system of the embodiment comprises at least a portable information apparatus 1 and a host information apparatus 2.

The portable information apparatus 1 is a portable information processing apparatus capable of exchanging information with the host information apparatus 2. The portable information apparatus 1 is, for example, a personal computer such as a notebook computer or a tablet computer. The host information apparatus 2 is a host apparatus capable of controlling the vehicle in accordance with a user operation. The host information apparatus 2 is configured to exchange information with the portable information apparatus 1. The host information apparatus 2 is installed in a vehicle such as an automobile in advance. The host information apparatus 2 controls, for example, setting of several pieces of equipment and functions in the vehicle, for example, setting of driver seat, setting of an audio/video apparatus, setting of a navigation apparatus, and setting of an air conditioner. Note that the host information apparatus 2 may have the function of the audio/video apparatus, the function of the navigation apparatus, and the like. Hence, the above-described personal setting information can be said to be setting information concerning the host information apparatus 2.

The portable information apparatus 1 and the host information apparatus 2 can wirelessly communicate (to be referred to as wireless connection hereinafter). By the wireless connection, the personal setting information can be transmitted and received between the portable information apparatus 1 and the host information apparatus 2.

In FIG. 1, the portable information apparatus 1 is a portable information processing apparatus held by one of the plurality of users who share the car. The portable information apparatus 1 transmits personal setting information (personal setting “A”) stored in the portable information apparatus 1 to the host information apparatus 2 (to be referred to as upload hereinafter). Then, the portable information apparatus 1 receives the personal setting information (personal setting B) from the host information apparatus 2 (to be referred to as download hereinafter).

The upload is automatically performed by using as a trigger which is or example the change of an engine state of the automobile from state of OFF to state of ON. The download is automatically performed by using as a trigger which is for example the change of an engine state of the automobile from state of ON to state of OFF. That is, if the user starts using the automobile, the personal setting “A” of the user is automatically applied to (reflected on) the automobile. If the user ends using the automobile, the personal setting B representing the setting contents currently which set in the automobile is stored in the portable information apparatus 1. If the vehicle settings have not been changed by manual operation or the like of the user for the host information apparatus 2, the personal setting B equals the personal setting “A”. However, if the vehicle settings have been changed by the manual operation or the like of the user a user for the host information apparatus 2, the personal setting B is different from the personal setting “A”. For this reason, the current personal setting information (the personal setting B) is information associated with the personal setting information (the personal setting “A”) and the current personal setting information represents the current setting contents of the car. The current setting (the personal setting B) of the automobile is downloaded to the portable information apparatus 1 by using, for example, a trigger representing the state of the automobile engine OFF. This allows to back up the contents of the latest personal setting updated during driving to the portable information apparatus 1. In this case, the contents of the personal setting B are reflected on the personal setting “A” in the portable information apparatus 1. The personal setting “A” in the portable information apparatus 1 may be updated to the latest state. This allows to automatically apply (reflect) the latest personal setting “A” to (on) the car, wherein the latest personal setting “A” is updated at the end of the preceding driving.

As described above, in the embodiment, the personal setting information concerning the car of interest is held on the side of the portable information apparatus 1. For example, if the engine of the car is turned on, the personal setting information is uploaded to the host information apparatus 2 in the car and thus the personal setting is applied to the car (various kinds of onboard apparatuses of the car). If the engine of the car is turned off, the current personal setting information is downloaded from the host information apparatus 2 to the portable information apparatus 1. The personal setting information is stored in the portable information apparatus 1. This allows to automatically set the shared car by using the personal setting information stored in the portable information apparatus 1, wherein the portable information apparatus 1 is a personal belonging of the user. It is also possible to hold (profile) the personal setting information for each of the cars using the single portable information apparatus 1. Since the host information apparatus 2 need not hold the personal setting information of each user, the capacity of memory can be prevented from becoming too large. For this reason, not only the “driving position” but also another setting information such as the “navigation log” or “music/moving image play lists” can be uploaded within the range of the capacity of the memory on the host information apparatus 2.

For example, only during the time the user is using the automobile, the personal setting information stored in the portable information apparatus 1 is set in the host information apparatus 2. Hence, the personal setting information is not always stored in the host information apparatus 2. The personal setting information is also automatically set based on ON/OFF switching of the automobile engine or lock/unlock switching of the automobile doors. For this reason, the user need not do a complex operation necessary for setting the personal setting information.

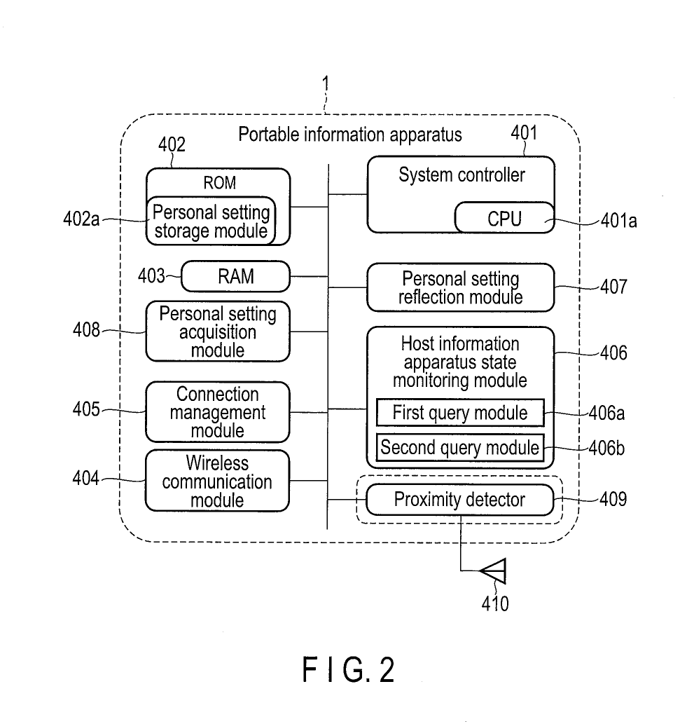

An example of the system arrangement of the portable information apparatus 1 will be described next with reference to FIG. 2.

The portable information apparatus 1 comprises a system controller 401, a ROM 402, a RAM 403, a wireless communication module 404, a connection management module 405, a host information apparatus state monitoring module 406, a personal setting reflection module 407, a personal setting acquisition module 408, and a proximity detection module 409. These components are connected to each other via a bus.

The system controller 401 comprises a central processing unit (CPU) 401a. The ROM 402 stores various kinds of application programs, driver programs, and the like for controlling the functional blocks in the portable information apparatus 1 as shown in FIG. 2. The CPU 401a is a processor that controls the operations of the modules in the portable information apparatus 1. The CPU 401a executes various kinds of application programs, various kinds of driver programs loaded, and the like from the ROM 402 to the RAM 403, for example.

The ROM 402 further comprises a personal setting storage module 402a. The personal setting storage module 402a stores the personal setting information. The personal setting information is setting information representing a personal setting concerning the vehicle. The ROM 402 may be an electrically rewritable nonvolatile memory. The RAM 403 stores data under processing and data on a stack.

The wireless communication module 404 is a communication module that executes wireless communication. The wireless communication module 404 executes communication with an external apparatus (for example, the host information apparatus 2) via the wireless connection (link) established between the external apparatus (for example, the host information apparatus 2) and the portable information apparatus 1.

The connection management module 405 establishes and disconnects the wireless connection (link) of the wireless communication module 404. More specifically, the connection management module 405 controls the wireless communication module 404 to execute processing of establishing the wireless connection between the wireless communication module 404 and the external apparatus. The connection management module 405 also controls the wireless communication module 404 to execute processing of canceling (discontenting) the wireless connection between the wireless communication module 404 and the external apparatus.

The connection management module 405 automatically starts the processing of establishing the wireless connection between the host information apparatus 2 and the portable information apparatus 1 (the wireless communication module 404) using, for example, activation of the host information apparatus 2 as the trigger. The host information apparatus 2 is activated by, for example, car-engine-ON, car-door-unlock using the electronic key, or the like.

The host information apparatus state monitoring module 406 acquires the current state of the host information apparatus 2 and monitors whether the state of the host information apparatus 2 is a state capable of setting the personal setting information in the host information apparatus 2. The host information apparatus state monitoring module 406 also monitors whether the state of the host information apparatus 2 is a state capable of acquiring the personal setting information from the host information apparatus 2. The states of the host information apparatus 2 are roughly divided into an “initial setting state” and a “personal setting completion state”.

The “initial setting state” is a state capable of applying (reflecting) the personal setting information to (on) the host information apparatus 2 (the car). More specifically, the “initial setting state” means a state capable of applying the personal setting to the host information apparatus 2, that is, the car. The personal setting is represented by the personal setting information stored in the portable information apparatus 1 apparatus. The “personal setting completion state” is a state capable of acquiring the personal setting information from the host information apparatus 2. More specifically, the “personal setting completion state” means a state in which the personal setting represented by the personal setting information stored in the portable information apparatus 1 is applied to the host information apparatus 2, that is, the car.

The host information apparatus state monitoring module 406 comprises a first query module 406a and a second query module 406b. The first query module 406a inquires of the host information apparatus 2 via the wireless connection whether the state of the host information apparatus 2 is the above-described “initial setting state” (first state) capable of applying the personal setting represented by the personal setting information to the car. The second query module 406b inquires of the host information apparatus 2 via the wireless connection whether the state of the host information apparatus 2 is the state capable of acquiring the current personal setting applied to the car from the host information apparatus 2, that is, whether the state of the host information apparatus 2 is the above-described “personal setting completion state” in which the applying for the personal setting is completed.

Processing of inquiring whether the state of the host information apparatus 2 is the “personal setting completion state” is automatically executed in response to, for example, occurrence of a termination event to terminate the operation of the host information apparatus 2. The termination event occurs upon, for example, the car engine OFF, the car door lock using such as the electronic key, or the like. Note that the portable information apparatus 1 may periodically monitor the state of the host information apparatus 2 by polling (periodically inquiring) the host information apparatus 2 about the state of the host information apparatus 2. This makes it possible to determine whether the host information apparatus 2 is in the “personal setting completion state” or the “initial setting state”. The polling also enables to detect not only the above-described “personal setting completion state” and “initial setting state” but also various other states of the host information apparatus 2, for example, whether the host information apparatus 2 is executing termination processing and whether activation of the host information apparatus 2 has started, and the like. This makes it possible to download information associated with the current car setting from the host information apparatus 2 to the portable information apparatus 1 without causing the user to operate the portable information apparatus 1. The personal setting information stored in the portable information apparatus 1 can thus be updated to the latest contents.

The personal setting reflection module 407 functions as an upload module for uploading the personal setting information to the host information apparatus 2. If the state of the host information apparatus 2 monitored by the host information apparatus state monitoring module 406 is the “initial setting state”, the personal setting reflection module 407 uploads the personal setting information stored in the personal setting storage module 402a to the host information apparatus 2 via the wireless connection. On the other hand, if the state of the host information apparatus 2 is not the “initial setting state” but the “personal setting completion state”, the personal setting reflection module 407 does not execute the processing of uploading the personal setting information stored in the personal setting storage module 402a to the host information apparatus 2.

As described above, the upload of the personal setting information to the host information apparatus 2 is performed only the case that the state of the host information apparatus 2 is the “initial setting state”. Hence, if the personal information uploaded from a given portable information apparatus is already applied to the car, this setting can be prevented from being changed by the personal setting information newly uploaded from another portable information apparatus.

The personal setting acquisition module 408 functions as a download module for downloading the personal setting information from the host information apparatus 2. If the state of the host information apparatus 2 monitored by the host information apparatus state monitoring module 406 is the “personal setting completion state”, the personal setting acquisition module 408 downloads the current personal setting information from the host information apparatus 2. On the other hand, if the state of the host information apparatus 2 is not the “personal setting completion state” but the “initial setting state”, the personal setting acquisition module 408 does not execute the processing of downloading the personal setting information from the host information apparatus 2.

If the host information apparatus 2 is in the “initial setting state”, the current setting contents of the car may include information that is not relevant to the personal setting information “A” stored in the portable information apparatus 1. Then, assume a case in which the personal setting information download from the host information apparatus 2 is executed even if the host information apparatus 2 is in the “initial setting state”. In this case, the contents of the personal setting information “A” stored in the portable information apparatus 1 may erroneously be changed. In the embodiment, the downloaded personal setting information is executed only if the state of the host information apparatus 2 is the “personal setting completion state”. It is therefore possible to prevent the contents of the personal setting information “A” stored in the portable information apparatus 1 from erroneously being changed to an initial set value or the like.

The proximity detection module 409 detects that the distance between the host information apparatus 2 and the portable information apparatus 1 is set in a proximity state. The proximity detection module 409 is connected to an antenna 410. The antenna 410 is used to transmit and/or receive a radio signal. For example, the portable information apparatus 1 can receive, via the antenna 410, a radio signal transmitted from the host information apparatus 2 to detect the proximity state.

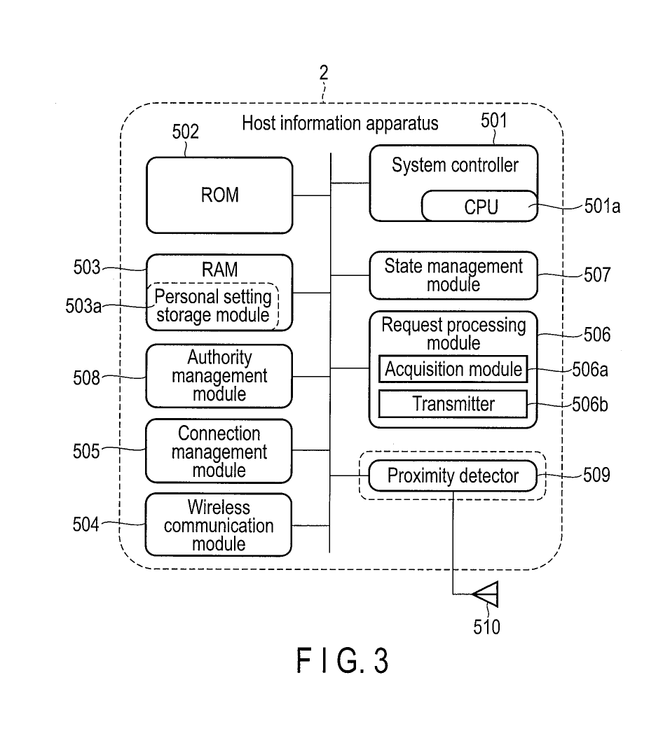

An example of the system configuration of the host information apparatus 2 will be described next with reference to FIG. 3.

The host information apparatus 2 is configured to permit the personal setting information uploaded from only the single portable information apparatus and download to only the single portable information apparatus, during activation and termination of the host information apparatus 2.

The host information apparatus 2 comprises a system controller 501, a ROM 502, a RAM 503, a wireless communication module 504, a connection management module 505, a request processing module 506, a state management module 507, an authority management module 508, and a proximity detector 509.

The system controller 501 performs control necessary for processing to be executed in the host information apparatus 2 via a system bus or the like. The system controller 501 comprises a central processing unit (CPU) 501a. The CPU 501a is a processor that controls the operations of the modules in the host information apparatus 2. The CPU 501a executes application programs and the like loaded, for example, from the ROM 502 to the RAM 503.

The ROM 502 stores the application programs, driver programs, and the like for controlling the functional blocks in the host information apparatus 2 as shown in FIG. 3.

The RAM 503 stores data under processing and a stack during the operation of the host information apparatus 2. The RAM 503 further comprises a personal setting storage module 503a. The personal setting storage module 503a is an storage area to store the personal setting information.

The wireless communication module 504 performs processing for the wireless connection. The wireless communication module 504 performs, for example, processing necessary for establishing the wireless connection.

The connection management module 505 manages connection. The connection management module 505 performs, for example, processing of establishing or disconnecting the wireless connection link established by the wireless communication module 504 between the portable information apparatus 1 and the host information apparatus 2.

The request processing module 506 receives a request such as a command transmitted from the portable information apparatus 1, for example, the personal setting reflection module 407 and performs processing for the request. The request processing module 506 further comprises an acquisition module 506a and a transmitter 506b. The acquisition module 506a functions as a receiving module that receives the personal setting “A” from the portable information apparatus 1 in accordance with an upload request from the portable information apparatus 1 to set the personal setting “A” in the host information apparatus 2. The transmitter 506b is a transmission module configured to perform a transmission processing to transmit the personal setting B to the portable information apparatus 1 in accordance with a download request from the portable information apparatus 1. The download request is a request to download the personal setting B from the host information apparatus 2 to the portable information apparatus 1. Note that whether to perform reception processing and/or transmission processing may be determined based on the state of the state management module 507. In this case, if the state of the host information apparatus 2 is the “initial setting state” capable of applying the personal setting to the vehicle, the acquisition module 506a receives the personal setting information “A” from the portable information apparatus 1 via the wireless connection in accordance with the upload request from the portable information apparatus 1. Based on the personal setting information “A” received from the portable information apparatus 1, the CPU 501a applies the personal setting represented by the personal setting information “A” to the car.

The CPU 501a can also change car setting in accordance with the user operation on the input apparatus (for example, touch panel, buttons/switches, or various kinds of other user interfaces) of the host information apparatus 2. If the state of the host information apparatus 2 is the “personal setting completion state” in which the personal setting is applied to the vehicle, the transmitter 506b transmits the personal setting information B representing the current setting contents to the portable information apparatus 1 via the wireless connection in accordance with a download request from the portable information apparatus 1.

The state management module 507 manages the state of the host information apparatus 2. The state is the above-described initial setting state or the personal setting completion state.

The authority management module 508 manages authority to change the personal setting information. Assume a case in which the state managed by the state management module 507 is the personal setting completion state (second state) in which the personal setting “A” of the portable information apparatus 1 is applied. In this case, the authority management module 508 can reject the upload request for the personal setting from a second portable information apparatus different from the portable information apparatus 1 and the download request from the second portable information apparatus to acquire the current personal setting B of the vehicle.

The proximity detector 509 detects that the distance between the host information apparatus 2 and the portable information apparatus 1 is set in a proximity state. The proximity detector 509 is connected to an antenna 510. The antenna 510 is used to transmit and/or receive a radio signal. For example, the host information apparatus 2 can receive, via the antenna 510, a signal representing that the portable information apparatus 1 has come closer to the host information apparatus 2. In addition, the host information apparatus 2 can transmit, via the antenna 510, a signal to detect the portable information apparatus 1 to the periphery of the host information apparatus 2.

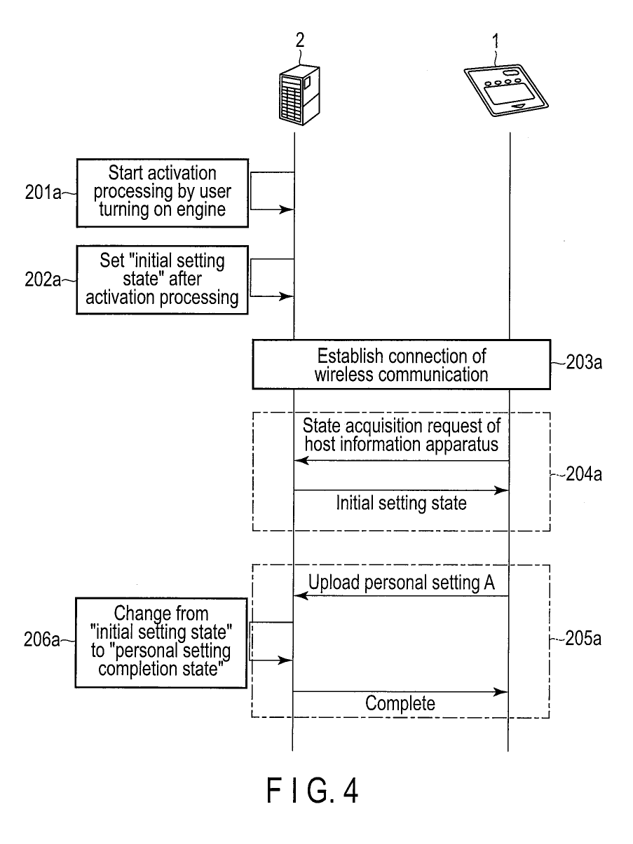

An example of the timing of processing to be performed between the portable information apparatus 1 and the host information apparatus 2 in uploading the personal setting information, will be described next with reference to FIG. 4.

First, if the user turns on the automobile engine, the host information apparatus 2 starts activation processing (step 201a). If the activation processing is completed, the host information apparatus 2 is set in the initial setting state (step 202a). Then, the wireless connection is established between the host information apparatus 2 and the portable information apparatus 1 (step 203a). In processing of establishing the wireless connection between the host information apparatus 2 and the portable information apparatus 1, for example, one of the host information apparatus 2 and the portable information apparatus 1 may transmit a connection request signal, and the other may transmit a response signal representing acceptance of the connection request signal. The portable information apparatus 1 starts monitoring the state of the host information apparatus 2 (step 204a). Monitoring the state of the host information apparatus 2 is performed by, for example, causing the portable information apparatus 1 to transmit a state acquisition request signal to the host information apparatus 2 to inquire about state of the host information apparatus 2. If the state of the host information apparatus 2 is the “initial setting state”, the host information apparatus 2 transmits an initial setting response signal to the portable information apparatus 1. The initial setting response signal is a signal that responds to the state acquisition request signal and represents the “initial setting state”.

Upon receiving the initial setting response signal, the portable information apparatus 1 uploads, to the host information apparatus 2, the personal setting “A” concerning the host information apparatus 2 and stored in the portable information apparatus 1 (step 205a). Upon receiving the personal setting “A”, the host information apparatus 2 performs processing of setting the personal setting “A” in the host information apparatus 2 and/or applying the personal setting “A” to the car. Note that details of the processing of applying (reflecting) the personal setting “A” to (on) the automobile will be described later. If setting the personal setting “A” in the host information apparatus 2 and/or applying the personal setting “A” to the car has succeeded, the host information apparatus 2 transits the state of the host information apparatus 2 from the “initial setting state” to the “personal setting completion state” (step 206a). The host information apparatus 2 sends a completion notification representing that the personal setting “A” is set in the host information apparatus 2, that is, that the personal setting “A” is applied to the car (step 205a). Note that if setting the personal setting “A” in the host information apparatus 2 and/or reflecting the personal setting “A” on the car has failed, the host information apparatus 2 does not transit the state of the host information apparatus 2 to the “personal setting completion state” and maintains the “initial setting state”. In this case, the host information apparatus 2 sends, to the portable information apparatus 1, a notification representing that setting the personal setting “A” in the host information apparatus 2 and/or reflecting the personal setting “A” on the car has failed. Then, note that the wireless connection may be disconnected or remain established between the host information apparatus 2 and the portable information apparatus 1.

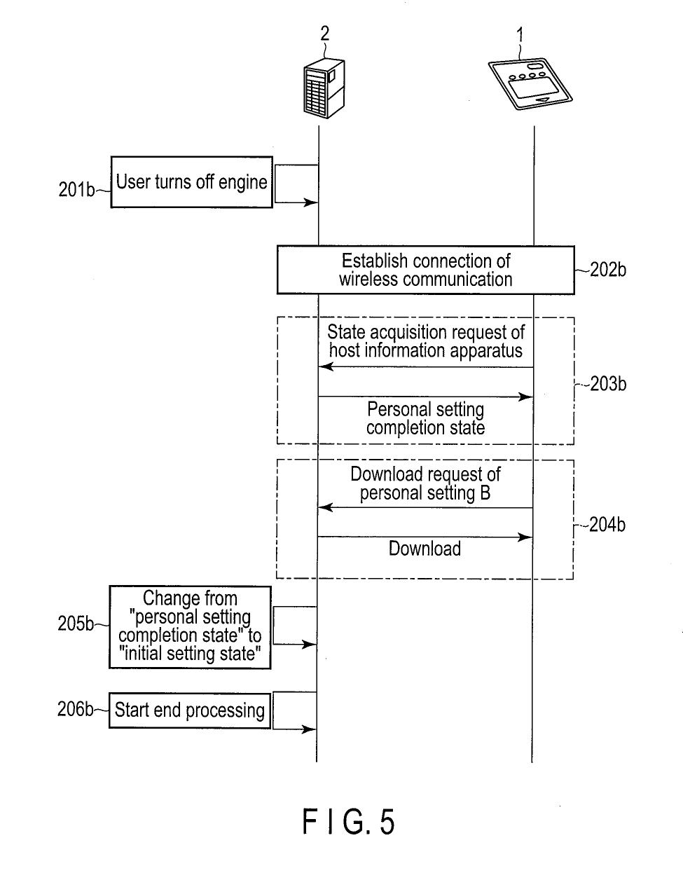

An example of the timing of processing to be performed between the portable information apparatus 1 and the host information apparatus 2 in a case of downloading the personal setting information will be described next with reference to FIG. 5.

If the user turns off the automobile engine (step 201b), the wireless connection is established between the host information apparatus 2 and the portable information apparatus 1 (step 202b). The portable information apparatus 1 starts monitoring the state of the host information apparatus 2 (step 203b). Monitoring the state of the host information apparatus 2 is performed by, for example, causing the portable information apparatus 1 to transmit the state acquisition request signal to the host information apparatus 2 to inquire about the state of the host information apparatus 2. If the state of the host information apparatus 2 is the “personal setting completion state” (step 203b), the host information apparatus 2 transmits a personal setting completion response signal to the portable information apparatus 1. The personal setting completion response signal is a signal that responds to the state acquisition request signal and represents the “personal setting completion state”. Note that if the host information apparatus 2 is not in the “personal setting completion state”, the host information apparatus 2 may send, to the portable information apparatus 1, a notification to, for example, instruct the portable information apparatus 1 to perform query again.

Upon receiving the personal setting completion response signal, the portable information apparatus 1 transmits, to the host information apparatus 2, a download request signal to download the personal setting B set in the host information apparatus 2 (step 204b). Upon receiving the download request signal, the host information apparatus 2 performs processing of downloading the personal setting B (step 204b). Then, the host information apparatus 2 transits the state of the host information apparatus 2 from the “personal setting completion state” to the “initial setting state” (step 205b). Note that the portable information apparatus 1 and the host information apparatus 2 may execute the download processing every time the host information apparatus 2 ends the operation, that is, for example, the automobile engine is turned off. In other words, if the host information apparatus 2 ends the operation, the portable information apparatus 1 and the host information apparatus 2 may automatically execute the above-described processing without inquiring of the user about the necessity of download. The host information apparatus 2 performs termination processing (step 206b). The termination processing is processing of, for example, transiting the state of the activated host information apparatus 2 from an operating state to a standby or off state, and details will be described later. Note that the wireless connection may be disconnected in the termination processing.

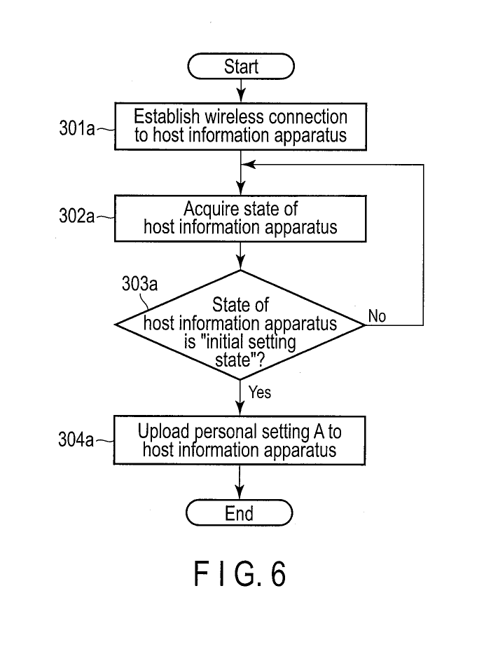

An example of the procedure of processing of the portable information apparatus 1 in a case of uploading the personal setting information will be described next with reference to the flowchart of FIG. 6.

If the user turns on the automobile engine, the host information apparatus 2 is initialized. If the initialization is completed, the state of the host information apparatus 2 changes to the “initial setting state”. The wireless communication module 404 establishes the wireless connection between the host information apparatus 2 and the portable information apparatus 1 (step 301a). If the wireless connection is established, the host information apparatus state monitoring module 406 starts monitoring the state of the host information apparatus 2 to acquire the state of the host information apparatus 2 (step 302a). It is determined based on the result of monitoring the state of the host information apparatus 2 by the host information apparatus state monitoring module 406 whether the state of the host information apparatus 2 is the “initial setting state” (step 303a). If the state of the host information apparatus 2 is not the “initial setting state” (NO in step 303a), the process returns to step 302a to, for example, cause the first query module 406a to inquire about the state of the host information apparatus 2 again. If the state of the host information apparatus 2 is the “initial setting state” (YES in step 303a), the personal setting reflection module 407 uploads, to the host information apparatus 2, the personal setting “A” concerning the host information apparatus 2 and stored in the personal setting storage module 402a of the portable information apparatus 1 (step 304a).

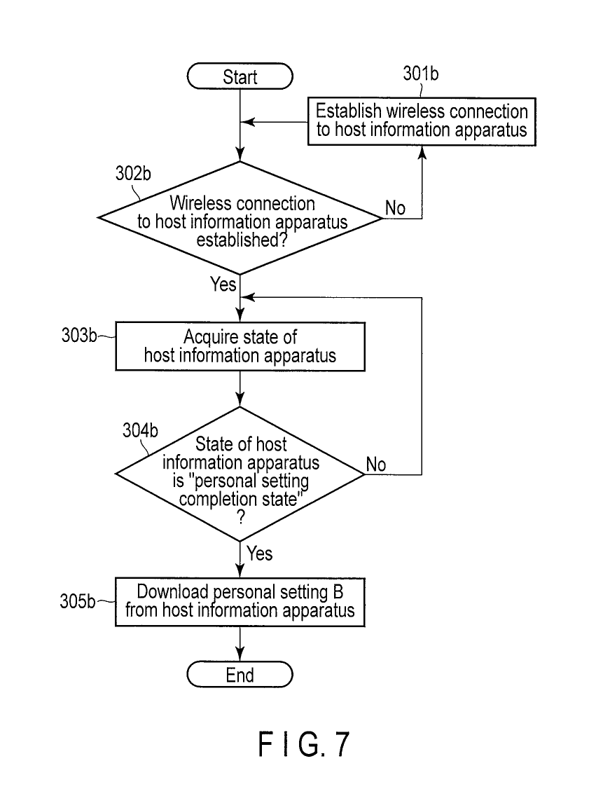

An example of the procedure of processing of the portable information apparatus 1 in case of downloading the personal setting information will be described next with reference to the flowchart of FIG. 7.

If the user turns off the automobile engine, it is determined whether the wireless connection is established between the host information apparatus 2 and the portable information apparatus 1 (step 302b). Upon determining that the wireless connection is not established (NO in step 302b), the wireless communication module 404 performs processing of establishing the wireless connection between the host information apparatus 2 and the portable information apparatus 1 (step 301b). Upon determining that wireless connection is established (YES in step 302b), the host information apparatus state monitoring module 406 can start monitoring the state of the host information apparatus 2. The host information apparatus state monitoring module 406 performs processing of acquiring the state of the host information apparatus 2 (step 303b). For example, the second query module 406b sends the above-described query to the host information apparatus 2.

It is determined, based on the result of monitoring the state of the host information apparatus 2 by the host information apparatus state monitoring module 406, whether the state of the host information apparatus 2 is the “personal setting completion state” (step 304b). If the state of the host information apparatus 2 is not the “personal setting completion state” (NO in step 304b), the process returns to step 303b. If the state of the host information apparatus 2 is the “personal setting completion state” (YES in step 304b), the personal setting acquisition module 408 downloads the personal setting B from the host information apparatus 2 (step 305b). Thus downloading the personal setting B allows to back up and update the personal setting information of the user.

Note that a case in which reupload or redownload is performed after upload or download is performed once, will be described.

For example, assume a case in which each of a plurality of portable information apparatuses set respective personal setting information in the host information apparatus 2. In this case, assume that a portable information processing apparatus (to be referred to as a second portable information apparatus hereinafter) different from the portable information apparatus 1 that has uploaded the personal setting “A” as shown in FIG. 1 attempts to perform the upload. In this case, the host information apparatus 2 performs processing of allowing not to perform the upload from the second portable information apparatus.

On the other hand, if not the second portable information apparatus but the portable information apparatus 1 performs the reupload, the host information apparatus 2 performs processing of permitting the upload. If performing the redownload as well, the host information apparatus 2 performs processing of permitting the download for the portable information apparatus 1 that requests the redownload but processing of prohibiting the download for the second portable information apparatus that requests the redownload.

As described above, in the embodiment, if the personal setting information is to be reuploaded or the current personal setting information is to be redownloaded after the host information apparatus 2 has been set in the personal setting completion state, only the portable information apparatus 1 that has done personal setting in the host information apparatus 2 is authorized to do the reupload and the download. That is, although the plurality of portable information apparatuses can wirelessly be connected to the host information apparatus 2, only the portable information apparatus 1 that has done firstly the personal setting can perform the operation concerning the personal setting.

Note that the reupload is performed if, for example, the personal setting information stored in the portable information apparatus 1 has undergone processing such as change or update in the portable information apparatus 1. As described above, processing of the download is always performed at the time of termination processing as shown in FIG. 5. However, the redownload may be done at a timing other than the termination processing, for example, before the termination processing. In this case, the processes of steps 205b and 206b in FIG. 5 may be omitted.

Referring to FIG. 1, the personal setting information (the personal setting “A” in FIG. 1) at the time of the upload and the personal setting information (the personal setting B in FIG. 1) at the time of the download are different. This is because after the personal setting “A” is set in the host information apparatus 2, the personal setting information set in the host information apparatus 2 is updated, for example, based on the personal setting “A” or in accordance with a user operation using a user interface or the like.

The above-described processing will be described in more detail.

The trigger in the embodiment will be described first.

Processing of establishing the wireless connection, upload processing, and processing of activating the host information apparatus 2 may start using, as a trigger, the automobile engine ON, bringing the portable information apparatus 1 closer to the host information apparatus 2, the automobile door unlock using the electronic key, or the like.

The processing of establishing the wireless connection may start using the start of the processing of activating the host information apparatus 2 as a trigger.

The processing of the download and processing of transiting the host information apparatus 2 to the standby state may start using the automobile engine OFF, the bringing the portable information apparatus 1 closer to the host information apparatus 2, or the like as a trigger.

As for the bringing the portable information apparatus 1 closer to the host information apparatus 2, a case can be assumed in which, for example, after the automobile engine is turned on, the portable information apparatus 1 is brought closer to the host information apparatus 2, thereby starting the upload. Then, the portable information apparatus 1 is moved away from the host information apparatus 2 and then brought closer to the host information apparatus 2 again to start the download. Note that the bringing the portable information apparatus 1 closer to the host information apparatus 2 may be the moving the portable information apparatus 1 away from the host information apparatus 2 in the proximity.

The host information apparatus 2 may be activated by a user's predetermined operation. The predetermined operation is, for example, an operation of causing the user to activate the host information apparatus 2 via the portable information apparatus 1 or an operation of causing the user to operate a button or the like installed in the automobile to activate the host information apparatus 2.

The above-described portable information apparatus 1 need only be a compact information apparatus capable of communicating with the host information apparatus 2. The portable information apparatus may be not a computer but, for example, a cellular phone, a smartphone, or a PDA.

The portable information apparatus 1 can store a plurality of pieces of the personal setting information. For example, in case that the user uses a plurality of automobiles, the portable information apparatus 1 can store the personal setting information corresponding to each of the plurality of automobiles, in other words, a profile for each model (profiling).

It is one of the portable information apparatus 1 that communicates with the host information apparatus 2, as described above. However, it is possible to communicate between the host information apparatus 2 and each of two or more different portable information apparatuses. However, the portable information apparatus 1 capable of changing the personal setting information set in the host information apparatus 2 is the portable information apparatus 1 that has established connection to the host information apparatus 2 for the first time, in other words, the portable information apparatus 1 that has uploaded the personal setting “A” to the host information apparatus 2. That is, the personal setting information set in the host information apparatus 2 is exclusive and is never changed by another terminal different from the terminal that has uploaded the personal setting information. The each of two or more different portable information apparatuses may establish the wireless connection to the host information apparatus 2 simultaneously.

An example in which two or more different portable information apparatuses communicate with the host information apparatus 2 will be described. For example, assume that the personal setting information has been set in the host information apparatus 2. Also assume that the second portable information apparatus has established the wireless connection to the host information apparatus 2. In this case, the second portable information apparatus can control to change setting information (to be referred to as nonpersonal setting information hereinafter) different from the personal setting information set in the host information apparatus 2, in other words, the personal setting information associated with the personal setting “A”. The nonpersonal setting information is personal setting information that is not personal setting information interfering with driver's driving such as the driver seat state. The nonpersonal setting information concerns, for example, music the driver listens to in the automobile. In addition, the second portable information apparatus can upload data associated with the nonpersonal setting information stored in the second portable information apparatus to the host information apparatus 2. Other users may thus be allowed to change the setting of music or the like.

As for the host information apparatus 2, it is equipment of the automobile. However, the host information apparatus 2 need not always be installed in the automobile. The host information apparatus 2 need only be installed in a machine associated with the personal setting information to be set in the host information apparatus 2. The host information apparatus 2 may be installed not in an automobile but in a means of transport such as a motorcycle or a boat. Since the host information apparatus 2 may be incorporated in the automobile or the like, a user interface such as the button to be used to operate the host information apparatus 2 without using the portable information apparatus 1 need not always be in the automobile.

The host information apparatus 2 need not always be equipment of the automobile or the like. More specifically, the host information apparatus 2 can be assumed to exist outside the automobile or the like. In this case, based on the personal setting information uploaded from the portable information apparatus 1 to the host information apparatus 2, the host information apparatus 2 may cause a part of the automobile or the like, for example, a module to control the parts of the automobile or the like, to perform processing of applying the personal setting information to the automobile or the like.

The processing of applying the personal setting information to the automobile or the like is processing of reflecting the personal setting information set in the host information apparatus 2 on the automobile or the like, based on the personal setting information uploaded from the portable information apparatus 1. As for the processing of reflecting the personal setting information, more specifically, if information about the seat position is set, a control module that is a part of the automobile to change the seat position is caused to perform processing of, for example, moving the seat position based on the information about the seat position.

It is assumed that the above-described host information apparatus 2 is a server having a small internal memory capacity. However, the host information apparatus 2 may be an apparatus functioning as a server independently of the internal memory capacity. More specifically, the host information apparatus 2 may have an internal memory capacity capable of storing at least the personal setting information and the nonpersonal setting information stored in the single portable information apparatus 1. In this case, the nonpersonal setting information includes the data of a content such as music. In this case, the automobile may have a small-capacity server different from, for example, a large-capacity cloud server as in a data center outside the automobile.

As for the wireless connection, the wireless connection need only be, for example, WiFi® or Bluetooth®. It does not limit that one of the host information apparatus 2 and the portable information apparatus 1 starts the connection processing. For example, assume a state in which the host information apparatus 2 searches for the portable information apparatus 1. In this case, the portable information apparatus 1 may transmit a signal to start the wireless connection to the host information apparatus 2.

The proximity state may be detected using, for example, TransferJet™. To detect the proximity state, the host information apparatus 2 may transmit a polling signal at a predetermined time interval.

In the car sharing, a plurality of users may share one automobile or one host information apparatus 2 by, for example, scheduling by the hour.

The electronic key will be described in more detail. The above-described electronic key is, for example, an automobile key to unlock the automobile doors. The electronic key may be a terminal different from the host information apparatus 2, that is, a terminal different from a terminal such as a smart key incorporated in the host information apparatus 2. However, the electronic key may be integrated with the host information apparatus 2.

In the embodiment, as for ID authentication for a plurality of the portable information apparatuses, for example, different IDs are assigned to each of the plurality of portable information apparatuses. More specifically, if starting the car sharing, for example, a unique ID can be assigned to the portable information apparatus 1 held by the user. The unique ID need only be able to distinguish the portable information apparatus 1 from other portable information apparatus. For example, the unique ID may be generated at random. In the embodiment, however, the host information apparatus 2 can upload or download the personal setting information based on state of the host information apparatus 2, independent on whether to authenticate the portable information apparatus by ID, as described above. Note that as for authentication processing of the portable information apparatus 1 by ID, it is assumed that the portable information apparatus 1 can set the personal setting information in the host information apparatus 2, and the personal setting information is set in the host information apparatus 2. In this case, the processing is performed to only authenticate that the portable information apparatus 1 is not the second portable information apparatus, that is, the user is not any other person. For this reason, the authentication processing of the portable information apparatus 1 by ID may be done via the cloud server as described above.

Details of termination processing of step 206b shown in FIG. 5 will be described next. The termination processing includes processing other than transiting the host information apparatus 2 to the standby state, as described above. For example, in step 206b, the host information apparatus 2 may perform processing of disconnecting the wireless connection established with respect to the portable information apparatus 1. In addition, the host information apparatus 2 may perform processing of setting the host information apparatus 2 to an initial setting based on initial setting information in step 206b. Note that the processing of setting the initial setting is different from the above-described processing of transiting to the initial setting state. The initial setting information is, for example, the default setting information of the host information apparatus 2 stored in advance in the host information apparatus 2. More specifically, if a plurality of users use the automobile, the initial setting information allows a user to drive the automobile even if the user who uses the automobile does not set the personal setting information in the host information apparatus 2. The initial setting information may be, for example, default setting information concerning the nonpersonal setting information such as the default setting of car navigation. After transmitting the personal setting B to the portable information apparatus 1, the host information apparatus 2 sets the initial setting based on the initial setting information. The initial setting may be set in case that the user is not driving the automobile. Note that the above-described standby state can be a state in which, for example, the host information apparatus 2 can be activated based on the above-described trigger to activate the host information apparatus 2. That is, the standby state is the default state of the host information apparatus 2.

In the termination processing of step 206b, a common setting may be set based on common setting information common to a plurality of predetermined users, instead of setting the initial setting based on the initial setting information. The common setting information is, for example, setting information common to a plurality of predetermined users who share the automobile in the car sharing. More specifically, the common setting information may be set in, for example, the host information apparatus 2 in advance by each of the plurality of predetermined users. Additionally, in the termination processing of step 206b, the host information apparatus 2 gives the portable information apparatus 1 the administrator authority of the host information apparatus 2. The state of the host information apparatus 2 set by the personal setting “A” uploaded from the portable information apparatus 1 may be defined as the “initial setting state”. The host information apparatus 2 receives an operation input to designate a personal setting or content to be held even after transition from the “personal setting completion state” to the “initial setting state”. The host information apparatus 2 may determine the personal setting or content to be held in the “initial setting state” in accordance with the operation input.

Alternatively, in the termination processing of step 206b, if the personal setting B transmitted to the portable information apparatus 1 remains in the host information apparatus 2 as information or data, the host information apparatus 2 may perform processing of erasing the information or the data.

In step 204a of FIG. 4, the portable information apparatus 1 inquires about the upload request. However, the query to request the upload of the personal setting “A” may be sent from the host information apparatus 2. The host information apparatus 2 may notify the portable information apparatus 1 that the host information apparatus 2 is in the initial setting state.

The CPU 501a may execute not only the application programs but also the OS loaded from the ROM 502 to the RAM 503.

The upload may include, for example, setting the personal setting information in the host information apparatus 2 or reflecting the personal setting information set in the host information apparatus 2 on the automobile or the like, in addition to transmitting personal setting information to the host information apparatus 2.

The download indicates for the portable information apparatus 1 to receive the personal setting information, for the portable information apparatus 1 to acquire the personal setting information, or for the host information apparatus 2 to transmit the personal setting information.

The personal setting “A” and the personal setting B shown in FIG. 1 are different. However, for example, if the personal setting “A” is uploaded but not updated in the host information apparatus 2, the personal setting “A” and the personal setting B may represent the information of the same personal setting.

In processing of the download as shown in FIG. 5, information of the current setting that is the setting information set in the host information apparatus 2 may be the setting information set in the host information apparatus 2 at the start of processing of the download.

The state management module 507 shown in FIG. 3 may manage not only the above-described states but also the activation state and standby state of the host information apparatus 2. The system controller 501 may perform the initialization as described above. The system controller 501 may perform processing of setting the initial setting or the common setting representing the above-described default state.

As described above, in the embodiment, the personal setting information concerning the car such as the automobile can be stored not in the host information apparatus 2 of the automobile or the like but in the portable information apparatus 1, wherein the portable information apparatus 1 can hold by the user. For this reason, if the automobile is used by a plurality of users, the personal setting information of each user need not be held in the host information apparatus 2. This allows to prevent the memory capacity of the host information apparatus 2 from becoming too large. It is therefore possible to, for example, upload not only the personal setting information but also another setting information such as the “navigation log” or “music/moving image play lists” within the capacity of the RAM of the host information apparatus 2. In addition, since the profile for each model for the automobile can be held in one portable information apparatus 1 and managed, the user need not carry a plurality of portable information apparatuses for the respective models. The authority to change the personal setting information set in the host information apparatus 2 by the upload is given to the portable information apparatus 1 that has uploaded the personal setting information, or the portable information apparatus 1 that has established the wireless connection to the host information apparatus 2 for the first time. This allows to prevent information concerning the personal setting from being changed by any person other than the driver.

The upload of personal setting information from the portable information apparatus 1 to the host information apparatus 2 is executed if the state of the host information apparatus 2 is the “initial setting state”. The download of personal setting information from the host information apparatus 2 to the portable information apparatus 1 is executed if the state of the host information apparatus 2 is the “personal setting completion state”. Hence, if the personal information uploaded from the portable information apparatus 1 is already applied to the car, this setting applied to the car can be prevented from being changed by the personal setting information newly uploaded from another portable information apparatus. This also allows to prevent the contents of the personal setting “A” stored in the portable information apparatus 1 from being erroneously changed to initial set values or the like. In addition, the portable information apparatus 1 inquires of the host information apparatus 2 about state of the host information apparatus 2, thereby operating not only as a mere medium to store the personal setting information but also as the subject in communication with the host information apparatus 2. Hence, the portable information apparatus 1 can also perform processing concerning the upload or the download in accordance with, for example, the user operation on the portable information apparatus 1.

In a conventional method of storing, in the host information apparatus 2, a table concerning the personal setting information associated with a plurality of IDs, the host information apparatus 2 needs to store an enormous amount of data including contents corresponding to the plurality of IDs. This can be avoided in the embodiment. The host information apparatus 2 and the portable information apparatus 1 are connected in a one-to-one correspondence. It is necessary to only maintain a state in which the personal setting information based on the updated personal setting information is set in the host information apparatus 2 during the time from the upload to the download. This allows to obviate the necessity for linking an ID with the personal setting information, that is, for associating the ID with the personal setting information as in a conventional method.

The user can automatically set the personal setting in the automobile only by approaching the automobile. If the user gets off the automobile, that is, turns off the engine, the personal setting information set in the automobile can be, for example, erased. This allows to prevent the personal setting information from being used by another person.

In the embodiment, the portable information apparatus 1 sends the query of the upload and the query of the download. This allows to prevent an operation of, for example, changing the personal setting information in case of the absence of the request from the portable information apparatus 1. That is, the method of the embodiment is different from the conventional method of simply exchanging data between the host information apparatus 2 and the portable information apparatus 1. That is, the portable information apparatus 1 does not serve as a storage medium for only storing the personal setting information and the like.

The functions of the modules as shown in FIGS. 2 and 3 of the embodiment can also be implemented by software (program). If the software is installed and executed in a computer via a computer-readable storage medium storing the software, the same effects as in the embodiment can easily be implemented.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A portable information processing apparatus capable of wireless communication with a host apparatus installed in a vehicle, the portable information processing apparatus comprising:
a connection module configured to establish a wireless connection between the portable information processing apparatus and the host apparatus;
a first query module configured to inquire via the wireless connection whether the host apparatus is in a first state capable of applying a personal setting to the vehicle, wherein the personal setting is represented by first setting information stored in the portable information processing apparatus;
an upload module configured to upload the first setting information to the host apparatus via the wireless connection if the host apparatus is in the first state;
a second query module configured to inquire via the wireless connection whether the host apparatus is in a second state in which the personal setting has been applied to the vehicle; and
a download module configured to download second setting information associated with the first setting information and representing current setting contents of the vehicle from the host apparatus via the wireless connection so as to reflect the second setting information to the first setting information in the portable information processing apparatus, if the host apparatus is in the second state.

2. The apparatus of claim 1, wherein the download module is further configured to execute the download when the host apparatus ends an operation.

3. The apparatus of claim 1, wherein the connection module is further configured to start establishing the wireless connection when the portable information processing apparatus and the host apparatus enter a proximity state.

4. The apparatus of claim 1, wherein the connection module is further configured to start establishing the wireless connection in response to activation of the host apparatus.

5. The apparatus of claim 1, wherein the connection module is further configured to start establishing the wireless connection based on an instruction of a user.

6. The apparatus of claim 1, further comprising a storage module configured to store the first setting information and another setting information, wherein the another setting information represents another personal setting associated with a second host apparatus different from the host apparatus.

7. A host apparatus installable in a vehicle, comprising:
a connection module configured to establish a wireless connection between the host apparatus and a portable information processing apparatus;
a management module configured to manage a state of the host apparatus;
a reception module configured to receive first setting information from the portable information processing apparatus via the wireless connection in accordance with an upload request from the portable information processing apparatus, if the managed state is a first state capable of applying a personal setting to the vehicle, wherein the personal setting is represented by the first setting information stored in the portable information processing apparatus;
a control module configured to apply the personal setting represented by the received first setting information to setting of the vehicle; and
a transmission module configured to transmit second setting information to the portable information processing apparatus via the wireless connection in accordance with a download request from the portable information processing apparatus, if the managed state is a second state in which the personal setting has been applied to the vehicle, wherein the second setting information is associated with the first setting information and represents current setting contents of the vehicle.

8. The apparatus of claim 7, wherein the transmission module is further configured to transmit the second setting information to the portable information processing apparatus in accordance with the download request from the portable information processing apparatus, when a termination event to terminate an operation of the host apparatus has occurred and the managed state is the second state.

9. The apparatus of claim 7, further comprising an authority management module configured to reject a personal setting upload request from a second portable information processing apparatus different from the portable information processing apparatus and to reject a download request from the second portable information processing apparatus to acquire the second setting information, if the managed state is the second state.

10. The apparatus of claim 7, wherein the control module is further configured to change the setting of the vehicle to a setting common for a plurality of users after the transmission module transmits the second setting information.

11. A vehicle control method of controlling a vehicle using a portable information processing apparatus capable of wireless communication with a host apparatus installed in the vehicle, the vehicle control method comprising:
establishing a wireless connection between the portable information processing apparatus and the host apparatus;
inquiring via the wireless connection whether the host apparatus is in a first state capable of applying a personal setting to the vehicle, wherein the personal setting is represented by first setting information stored in the portable information processing apparatus;
uploading the first setting information to the host apparatus via the wireless connection, if the host apparatus is in the first state;
inquiring via the wireless connection whether the host apparatus is in a second state in which the personal setting has been applied to the vehicle; and
downloading second setting information from the host apparatus via the wireless connection so as to reflect the second setting information to the first setting information in the portable information processing apparatus, if the host apparatus is in the second state, wherein the second setting information is associated with the first setting information and represents current setting contents of the vehicle from the host apparatus via the wireless connection.
